(19) United States
(12) Patent Application Publication
(10) Pub. No.: US 2022/0026397 A1
(43) Pub. Date: Jan. 27, 2022

(54) STRUCTURAL WALL INSPECTION SYSTEM USING DRONES TO PERFORM NONDESTRUCTIVE TESTING (NDT)

(71) Applicant: Voliro AG, Zurich (CH)

(72) Inventor: Mina Samir Fekry Kamel, Zurich (CH)

(21) Appl. No.: 16/934,950

(22) Filed: Jul. 21, 2020

(51) Int. Cl. G01N 29/265; B64C 39/02; G05D 1/00; G01N 27/90; G01N 29/24

(52) U.S. Cl. CPC G01N 29/265; G01N 2291/2698; G05D 1/0061; G01N 27/902; G01N 29/2412; G05D 1/0038; G05D 1/0094; B64C 2201/123; B64C 2201/141; B64C 2201/146; B64C 2201/024; B64C 2201/127; G01N 2291/0234; G01N 2291/02854; G01N 2291/0289; B64C 39/024

(57) ABSTRACT

A system for nondestructive inspection of structures. The system includes an omni-directional unmanned aerial vehicle (UAV) and a support arm extending outward from the UAV body from a first end attached to the body to a second distal end, which is used to support a nondestructive testing (NDT) sensor. The system includes an autopilot module stabilizing the flight of the omni-directional platform. The autopilot includes a wall-tracking mode, which determines the normal of the structure's surface, and the omni-directional UAV is stabilized to fly with the support arm aligned with normal to the surface and with the second end proximate to the surface with the UAV body in any orientation in space. The UAV operates to follow a flight path whereby a longitudinal axis of the support arm coincides with the normal and the sensor is positioned in predefined measurement position relative to the structure surface to take the measurements.

### BACKGROUND

### 1. Field of the Description

The present description relates, in general, to nondestructive testing (NDT) of objects including walls of vessels, tanks, pipes, and other containers (or “structures”) that are may be used to contain fluids such as oil, natural gas, chemicals, water, and the like. More particularly, the present description relates to a system configured to employ a drone (or unmanned aerial vehicle (UAV) or micro aerial vehicle (MAV) as these terms are used interchangeably herein) carrying and selectively deploying a NDT sensor(s) to inspect walls of objects or structures (“structural walls”) to determine its characteristics including its wall thickness (e.g., determine a vessel or tank wall thickness at operator chosen locations using nondestructive testing techniques).

### 2. Relevant Background

There are numerous settings across a wide variety of industries in which it is desirable to inspect structural walls. For example, in the oil and gas industry, safety and quality standards require inspections of structural integrity prior to initial use and during the operational life of the structures that are used to carry (e.g., a pipeline) or store (e.g., a tank, a vessel, or the like) oil or gas. In many cases, these inspections may be merely visual and involve an inspector looking for cracks or other damage. In the past, drones have been used to perform visual inspection of the exterior wall surfaces of structures, which has assisted inspectors in viewing surfaces that are difficult or nearly impossible to access such as those high above the ground. However, by the time a crack appears, a structure may not be in proper condition for continued use.

It is more desirable for the structural inspections to include determinations of wall thicknesses at various locations (e.g., at possible higher stress locations, at or near joints, and so on) on the structure. To this end, nondestructive testing (NDT) techniques are often used to determine wall thicknesses of a structure. NDT is the process of inspecting, testing, or evaluating materials, components or assemblies for discontinuities, or differences in characteristics without destroying the serviceability of the part or system. For example, a NDT sensor may be configured to use ultrasonic testing of a vessel wall to determine its thickness. The ultrasonic device has to not only be placed in close contact with the wall's outer surface, though, but a mating has to be achieved to provide for transmission of sound waves. There can be no air gap or barrier, and the sound-transfer is often achieved by providing a gel between the sensor and the exterior surface of the wall. This requirement to retain the sensor in contact with the exterior wall surface with a proper medium for sound transfer has made it difficult to utilize drones to position and use such NDT sensors for inspecting many structural walls, which has often led to an undesirable reliance on visual inspections using cameras mounted on drones that are flown about the structure under inspection.

Hence, there remains a need for improved methods and systems for performing inspections of structural walls using NDT techniques. Preferably, a new inspection system would be adapted to use UAVs or drones so that an inspector is able to remotely access and inspect all portions of a structure (e.g., an oil and gas tank, pipeline, or vessel) including those that would otherwise be difficult such as those that are high off the ground or otherwise hard to physically access (e.g., the curved top or bottom of a storage tank).

### SUMMARY

With the above challenges in mind, a structural wall inspection system was designed and prototyped that makes effective use of drones (or UAVs as these terms are used interchangeably herein) to locate surfaces for inspection, to orient a NDT sensor relative to a wall surface, to deploy the sensor, and to operate the NDT sensor to take measurements (such as to take measurements useful for determining a wall thickness). In some cases, orienting the NDT sensor properly includes determining a normal for the surface to be inspected and directing a support arm holding or supporting the NDT sensor to follow that normal to place the NDT sensor in contact with the surface. In these or other cases, a sensor positioning assembly is used to make the final contact with the surface using an actuator to extend a positionable support outward from an end of the support arm to move the sensor into contact or near the surface.

An attachment mechanism, such as a permanent magnet, may be used to hold the sensor in contact or near the surface during sensor measuring operations, and then the actuator may be operated to retract the positionable support and detach the attachment mechanism from the wall surface. The drone preferably may be an omnidirectional drone. Such drones are useful as they are configured to be able move and/or hover with its body in nearly any orientation relative to its central axes to allow the sensor support arm to be oriented in a desired manner for sensor deployment and to be able to perform the final or last step movements so as to follow a determined surface normal to place the sensor in contact with a wall surface regardless of its orientation (e.g., a bottom of a tank, any location on a curved vessel surface, and the like).

The new omnidirectional drone-based system provides a number of useful advantages over prior inspection techniques and processes. The system allows an inspector working in tandem with a drone pilot to perform inspection on surfaces of any orientation due to the omnidirectional aspect of the drone, and the system is able to maintain stable contact and collect measurements with nearly any type of NDT sensor. In some cases, the NDT sensor could be an Electromagnetic Acoustic Transducer (EMAT) to reduce or even eliminate the need for contact with the wall surface being inspected (or at least eliminate the need for a gel or other sound-transmitting medium). However, other NDT sensors may be used such as a piezoelectric ultrasonic transducer, a pulsed eddy current (PEC) sensor, or other type of device used in NDT inspections. An onboard sensor assembly in or on the body of the drone may be configured to provide the system with the ability to use cameras and lasers to stabilize the drone close to a structure and may even automate (or semi-automate) the process of collecting measurement (going in, taking reading and retreating, on a single button press by the inspector via their client device). To this end, the system typically includes a pilot interface (remote controller) to pilot the drone and an inspector interface (a tablet) to extend the sensor and collect measurements with the NDT sensor.

More particularly, a system is provided for inspecting a structure in a nondestructive manner. The system includes an omni-directional unmanned aerial vehicle (UAV) including a body (or central frame), and a support arm is included in the system that extends outward from the body from a first end attached to the body to a second end distal to the body. The system further includes a nondestructive testing (NDT) sensor mounted on or in the support arm at or near the second end. Also, the system includes an autopilot module or controller determining a normal of a surface of the structure and stabilizing flight of the omni-directional UAV with the support arm aligned with the normal to the surface and with the second end proximate to the surface. During system use, the omni-directional UAV operates in response to control signals, which are generated by the autopilot module or received from a radio controller based on the pilot input, to follow a flight path whereby a longitudinal axis of the support arm coincides with the normal to the surface and whereby the sensor is positioned in predefined measurement position relative to the surface of the structure. Further, the NDT sensor is operated by the inspector in the predefined measurement position to measure one or more parameters related to the surface of the structure.

In some embodiments of the system, the flight path is contained in a plane that is at an offset angle from a horizontal plane such that the omni-directional UAV allows the sensor to be provided at normal to the surface being inspected (which may have any orientation) with the body of the UAV at nearly any orientation in space required to provide the sensor at normal. In these embodiments, the surface is at least one of a nonplanar surface, a top surface, a bottom surface, and is a non-vertical planar sidewall of the structure.

In some implementations, the system includes a client device operating to provide a graphical user interface (GUI) on a display screen that allows the user of the client device to monitor the NDT sensor readings and control the process of measuring the parameters related to the surface of the inspected structure. In such implementations, the system may also include a camera capturing a video image of the surface, and the GUI is adapted to display the video image of the surface such that the user (or inspector) may readily initiate operation of the sensor when it is in a position near a surface they want to inspect.

In some useful embodiments, the NDT sensor is or includes an electromagnetic acoustic transducer (EMAT) sensor, and the one or more parameters includes a wall thickness of the structure. In such cases, the system may also include an attachment mechanism including a magnet mounted on the second end of the support arm with a mating surface extending outward a distance from the support arm from the EMAT sensor, whereby the magnet is attached to the surface when the sensor is positioned in the predefined measurement position. Also, in such cases, the system may further include a positioning assembly mounted on the support arm including a positionable support upon which the magnet and the EMAT sensor are affixed. Further, an actuator (e.g., a hydraulic or pneumatic pump) may be provided that operates prior to the measuring of the one or more parameters to extend the positionable support outward from the second end ofthe support arm to cause the magnet to be attached to the surface and place the EMAT sensor in the predefined measurement position.

In other useful embodiments, the NDT sensor is or includes a piezoelectric ultrasonic transducer (UT) sensor, and the one or more parameters includes a wall thickness of the structure. In such cases, the system further may include a mechanism mounted on the support arm proximate to the second end operating prior to the measuring of the one or more parameters by the UT sensor to dispense a gel onto the surface to provide a sound-transmitting medium or contact between the sensor and the surface. In still other embodiments, the NDT sensor is or includes a pulsed eddy current (PEC) sensor, and the one or more parameters includes corrosion or flaws under the surface of the structure. In these embodiments, the system may further include a sled or protective frame/guard mounted on the second end of the support arm outward from the PEC sensor, whereby the sled slides on the surface while periodic measurements are performed during the measurement of the one or more parameters by the PEC sensor. In some system implementations, the NDT sensor is or includes a dry-film thickness (DFT) sensor and the one or more parameters include a coating thickness on the surface of the structure.

In some embodiments, the system also includes one or more optical flow cameras and distance sensors on the body. In these systems, the autopilot module or a controller processes output of the optical flow cameras and/or the distance sensors to generate control signals to perform the stabilizing of the flight of the omni-directional UAV and/or to determine the normal to the surface of the structure and/or to align the UAV normal to the surface at a fixed distance.

### BRIEF DESCRIPTION OF THE DRAWINGS

FIG. 1 is a functional block diagram of a structural wall inspection system configured according to the present description to use one or more drones or UAVs to perform a NDT on one or more structural walls;

FIG. 2 is a schematic diagram of one useful implementation of the inspection system of FIG. 1 showing particular features of the system in further detail;

FIG. 3 illustrates schematically mission workflow or an inspection process showing a set of flight phases, labeled with reference numbers, for a drone configured according to the present description (e.g., as discussed with reference to FIGS. 1 and 2);

FIG. 4 is side perspective view of an omni-directional drone operating (e.g., hovering at a vertical height) to retain an NDT sensor (i.e., an EMAT sensor) in place for measurements of a structural wall surface;

FIG. 5 is a bottom perspective view of the drone of FIG. 4 operating to inspect an additional point on the surface of the structure of FIG. 4 showing an inspector using a client device to view collected measurements of structural wall thickness in real time;

FIG. 6 illustrates an exemplary inspection system of the present description during its operations to inspect a surface of structural wall with an omni-directional UAV carrying a PEC sensor; and

FIG. 7 illustrates another omni-direction drone configured to carry and position an NDT sensor in the form of a DFT sensor.

### DETAILED DESCRIPTION

Briefly, the following description is directed toward a new inspection system that is particularly well suited for performing NDT-type inspections of structural walls such as pipelines and storage tanks or vessels used in the oil and gas industry to remotely determine structural integrity (e.g., with wall thickness determinations). The inspection system includes omnidirectional drones or UAVs adapted to support a NDT sensor in a manner in which it can be deployed so as to be proximate to or contacting a surface of a wall under inspection.

More specifically, onboard sensors are used to collect data or information on a particular wall surface, and this sensor data is processed to determine the normal to the wall surface. The omnidirectional UAV is then controlled via pilot-provided control signals and/or system-generated autopilot signals to move a support arm holding the NDT sensor along a flight path matching (or substantially following) the determined normal (e.g., so that the elongate support arm's longitudinal axis is orthogonal to the surface to be inspected). The final deployment may involve an actuator (e.g., a hydraulic or pneumatic pump, an electronic motor, or the like) to extend a positionable support holding the NDT sensor outward from the end of the support arm, at which point the sensor may be in contact with (or adequately near for the sensor technology) the wall surface. This position may be held/retained by an attachment mechanism, e.g., a magnet (permanent magnet or electromagnet), and the NDT sensor may be operated to gather data on the wall, such as data useful for calculating the wall thickness adjacent the sensor.

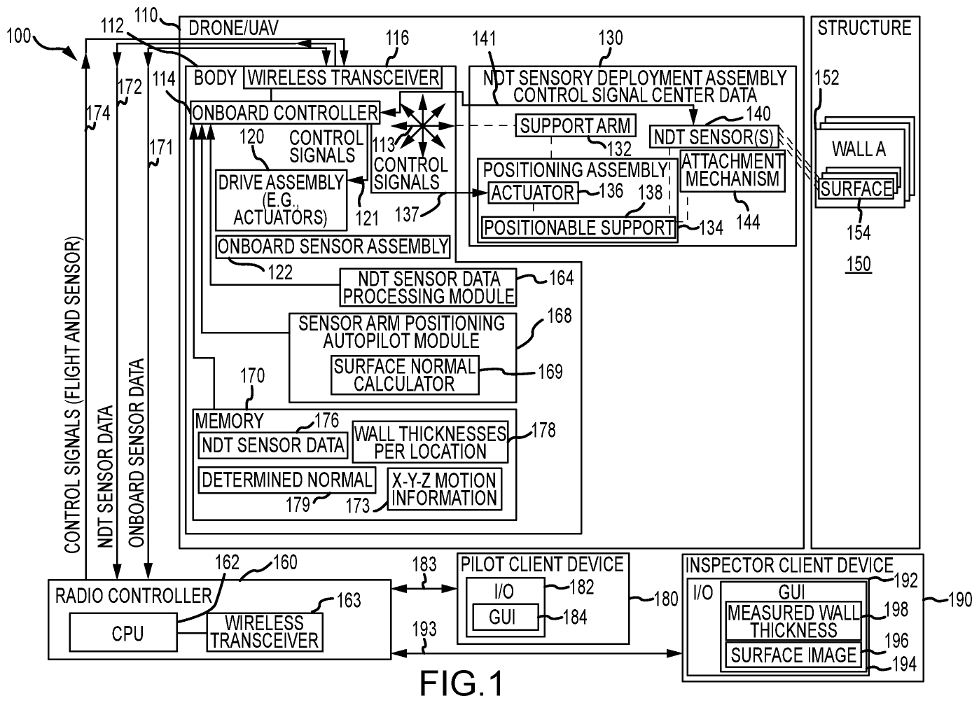

FIG. 1 illustrates a functional block diagram of a structural wall inspection system 100 of the present description. The system 100 includes a drone 110 with a body 112 that supports a drive assembly 120, e.g., a set of three, four, or more rotors each extending outward from the body 112 on elongate arms. An onboard controller 120 (e.g., processor(s) running software and/or firmware and memory devices) is provided on the body 112 to generate control signals 121 to operate the drive assembly 120 to provide desired 3D movements as shown with arrows 111, and it is desirable in many implementations of the system 100 for the drive assembly 120 and controller 114 to be adapted such that the drone/UAV 110 operates as an omni-directional drone that can maintain the body 112 in any desired orientation (as shown with arrows 113) during hovering and/or flight as shown with arrows 111. In this manner, the body 112 may be held horizontally as is common for most drones but also be held/retained at nearly any 3D orientation such as with a plane extending horizontally through a center point of the body 112 at any angle relative to vertical, horizontal, and other axes of the drone 110. In some prototypes, the drone 110 takes the form (with modifications as discussed to provide NDT sensing capabilities) of an omni-directional drone or UAV such as the 360° Drone (also known as “the omnidirectional hexacopter” and “six-axis drone”) available from Voliro Airborne Robotics or an omnidirectional drone, UAV, or multi-rotor copter available from Voliro or other distributors.

The drone 110 (prior to modifications for sensing as provided herein) may take the form of any omnidirectional drone taught in CH20190000131, filed Feb. 5, 2019, which is incorporated herein in its entirety. To this end, the drone 110 may take the form of a MAV with a central frame/body and a tail extending from the central frame along a first axis (e.g., the X-axis). The MAV may have at least two arms extending from the central frame and be able to rotate around at least one second axis (e.g., the Y-axis). The angular position of the arm with response to the second axis defining an arm rotation angle (“A1”), and the tail is equipped with a tail rotor spinning around a tail rotor axis that is parallel to a third axis (e.g., the Z-axis) that is orthogonal to the first and second axes. Each arm is equipped with two thrust motors controlling spinning in opposite direction of two coaxial rotors. The two coaxial rotors define a double rotor axis and can tilt together with respect to another tilting axis, which is perpendicular to the second axis. The angular position of the double rotor with respect to the double rotor axis defining a double rotor tilting angle. The MAV is able to exert forces and torques in all directions with high capability of the system to control position and orientation independently. This means the MAV can take any orientation including, for example, a level position, a vertical position, or an inclined position of the central frame of the MAV. The MAV can then stay stabilized in this orientation, with the possibility of moving while in that orientation.

The drone 110 includes a wireless transceiver 116 in or on the body 112 for communicating with a radio controller (RC) 160. The radio controller 160 includes a processor/firmware 162 managing operations of a wireless transceiver 163 to facilitate such communications. The RC 160 transmits pilot's commands 174 to the drone 110 for controlling the actuators 120. The radio controller 160 receives the drone's telemetry 171 that is displayed to the pilot (e.g., via GUI 184 of I/O 182 on client device 180). The drone 110 additionally includes, which includes onboard controller 114 that processes the pilot's commands 174 (such as with autopilot module 168 and/or with output from surface normal calculator (wall tracking module) 169) to generate the control signals 121 for actuators 120 to provide flight 111 with the body 112 in any 360-degree orientation 113. The drone 110 further includes an onboard sensor assembly 122, and data collected by this assembly 122 is used for further processing (as discussed below).

The onboard sensor assembly 122 may include a variety of sensors that allow the drone 110 to sense its current location along a flight path such as two, three or more optical flow cameras 122 (e.g., to provide X-Y-Z motion information 171 and 173 to determine a location of the drone 110, which may be processed by the onboard controller 114 of the autopilot system (e.g., with module 168 and/or module 169) to provide control signals 121 to stabilize the body 112 of the drone 110 by operating the actuators 120), one or more color cameras 122 (e.g., to assist the pilot while flying in first person view (FPV) mode, during operations of an NDT sensor 140 for documentation of inspection results and to create a 3D map of the surrounding area), a laser (e.g., a 3D LiDAR to detect and avoid obstacles and also to map the surround area) or other rangefinders to obtain distances to nearby surfaces, an inertial measurement unit (IMU) to report angular rate and linear acceleration, GNSS or other positioning sensors to determine present location (longitude, latitude, and altitude/elevation), a barometer to determine height, and the like. Further, output from range finders and/or laser may be used to provide three (or more) distance measurements, and the autopilot module 168 and/or onboard controller 114 (functioning to provide the autopilot functions described herein) may use a surface normal calculator 169 to determine a normal 179 of a surface 154 of a wall 152 of a structure 150 being inspected by the drone 110. The surface 154 may be planar or may be curved, and the onboard controller 114 (functioning to provide the autopilot functions described herein) may further operate a sensor arm positioning subroutine or program of module 168 to generate control signals 174 to cause the actuators 120 of the drone 110 to operate (e.g., in response to a “go” signal from a drone pilot) to move the body 112 using the determined normal 179 such that a sensor is positioned in a desired position relative to a surface 154 of a wall 152 of a structure 150.

In this regard, the drone 110 further includes an NDT sensor deployment assembly 130 that is supported by the body 112 so as to move 111 in unison or as a unit with the body 112 and to be positioned and/or oriented 113 by body movements. To this end, the assembly 130 includes an elongate support arm 132 that extends outward from a side of the body 112 such as between two adjacent rotor support arms in the drive assembly 120 so that it is spaced apart a distance from these portions of the drive assembly 120. The length of the support arm 132 is chosen to be great enough such that the end of the support arm 132 (or an end of a positionable support 138 when extended) is further from the body 112 than the nearby rotors of the drive assembly 120 such that an NDT sensor 140 can be placed against or near a surface 154 without the rotors contacting the surface 154.

The deployment assembly 130 includes one or more NDT sensors 140 for operation by an inspector to detect one or more parameters (such as wall thickness) of a surface 154 of a wall 152 of a structure 150. The NDT sensor may take any form useful for performing NDT sensing such as an ultrasonic sensor. In some embodiments, it is desirable for the sensor 140 to be an EMAT sensor, which is or includes a transducer for non-contact acoustic wave generation and reception in conducting materials. EMAT sensors may be desirable because their sensing is based on electromagnetic mechanisms, which do not need direct coupling with the surface of the material so that EMATs are useful in harsh, i.e., hot, cold, clean, or dry environments, and are suitable to generate all kinds of waves in metallic and/or magnetostrictive materials (e.g., for metal-walled structures 150).

The NDT sensor 140 may be provided in a fixed or rigid manner (or with some shock absorbing materials) on the outer end of the support arm 132. In other cases, though, a positioning assembly 134 is provided on (or in or partially in) the outer end of the support arm 132. The positioning assembly includes an actuator 136, such as an electronic actuation mechanism, a pneumatic pump, a hydraulic pump, or the like, that is operable in response to control signals 137 from the onboard controller that are generated in response to commands 174 from the radio controller 162. When actuated, the actuator 136 operates in a first state to extend a positionable support 138 (e.g., a rod, piston, or the like) from a retracted position into an extended position. The NDT sensor 140 is provided on an outer end of the support 138 so that it is extended outward an additional distance from the outer end of the support arm 132 (e.g., outward an additional 1 to 6 inches or more). This additional deployment places the NDT sensor 140 against (e.g., for UT sensors) or near (e.g., for EMAT sensors) the surface 154 of the wall 152.

To further achieve acceptable inspection results, an attachment mechanism 144 may be provided on or near the outer end of the positionable support 138, and the attachment mechanism 144 is configured to function to attach or retain the NDT sensor at its desired position relative to the surface 154 during its operations to collect sensor data 172. In one embodiment, the attachment mechanism 144 takes the form of one, two, or more magnets provided about the periphery of the NDT sensor 140 that, through magnetic forces, temporarily affix the end of the support 138 to the surface 154 of the wall 152. For example, the magnet may be a doughnut-shaped permanent magnet extending wholly or partially about the circumference of the outer or mating surface of the sensor to hold this sensor surface against or apart a predefined distance from the wall surface 154. A command 174 is provided by the pilot using a radio controller 160 to operate the NDT sensor 140 via onboard controller 114 as shown at 141. Then, the actuator 136 is later operated in a second state to retract the support 138 causing the attachment mechanism 144 to release the sensor 140 from the surface 154 (e.g., pull the support 138 with a force greater than the magnetic force provided by the permanent magnet(s) of attachment mechanism 144). As shown with arrows 141 and 172, data collected by the sensor 140 is stored in memory and also transmitted to the radio controller 162 display or visualization to the pilot.

As shown, the system 100 includes a pilot client device 180 that is communicatively linked as shown at 183 with the radio controller 160 as well as inspector client device 190 that is communicatively linked as shown at 193 with the system. Each may take the form of a desktop, laptop, notebook, tablet, or other computing device with I/O devices 182, 192 that include a monitor for displaying GUIs 184, 194 along with input devices such as touchscreens, keyboards, a mouse, or the like. During system operations, an operator (i.e., a drone pilot) of the pilot client device 180 is able to view information displayed on the GUI 184 by the radio controller 162 to facilitate generation of flight commands 174 to produce control signals that cause the actuators 120 to operate to fly 111 along a desired flight path near a structure 150 and the surfaces 154 of its walls 152.

The data 171 from the onboard sensor assembly 122 is processed by a surface normal calculator 169 to determine a normal 179 of one of the nearby surfaces 154, and the sensor arm positioning autopilot module 168 uses the present position and orientation 113 of the body 112 to stabilize the body 112 relative to the surface 154 and to move the body 112 so as to orient the body 112 and the support arm 132 in a predefined manner relative to the surface 154 (e.g., with the longitudinal axis of the support arm 122 colinear to the normal 179) and at a predefined pre-inspection distance. Then, the pilot may provide input via the radio controller 160 or I/O devices 182 to cause the body 112 to move into an inspection position and later away from such a position. In other embodiments, though, the autopilot module 168 operates to generate control signals 174 to cause this in and out movement to be performed automatically (e.g., upon a “go” selection by the pilot on the client device 180). In these or other embodiments, the autopilot module 168 may be configured to monitor whether a signal between the drone 110 and the radio controller 160 is maintained, and, when detected to be lost (for a predefined period of time), the module 168 may issue control signals 174 to cause an operational time out including retracting the sensor 140 via operation of the actuator 136.

In many cases, the drone pilot will work closely with an inspector who will be operating the inspector client device 190 concurrently with the pilot's operation of the device 180 to pilot the drone 110. Typically, the two will sit nearby to each other (or otherwise be in close communications), and the inspector will request that the drone 110 be flown on a flight path to inspect a particular structure 150 and its walls 152. When the inspector observes on their GUI 194 a surface image 196 that they wish to inspect (via images captured by cameras in the onboard sensor assembly 122), they will request the pilot to initiate pre-inspection operating states to properly position and orient the support arm 132 and the supported NDT sensor 140.

Then, after the pilot operates the drone (as discussed above) to position the sensor 140 in an inspection location near the surface 154, the inspector may initiate operations of the NDT sensor 140 such as with a “collect measurements” command in their GUI 194 or the like. This may result in control signals 174 and 137 to actuate the actuator 136 to finally position the sensor 140. Once the attachment mechanism 144 has engaged the surface 154 to hold the sensor 140 in a position relative to the surface 154, the inspector may further initiate, via GUI 192, control signals 174 and 141 through the autopilot and onboard controller 114 to cause the sensor 140 to operate to gather the sensor data 172, 176. The NDT sensor data processing module 164 may then process the data 177 to determine a wall thickness 178 associated with each sampled/inspected location (as documented based on drone positions or the like), which may be displayed as shown at 198 to the inspector via the GUI 194. Once sensor operations are complete, the autopilot may issue control signals 174 and 137 to cause the actuator 136 to retract the support 138, and the pilot via device 180 may issue control signals 174 and 121 to cause the drone 110 to move to a next inspection location.

As can be appreciated with an understanding of the system 100 of FIG. 1 and implementation examples described below with regard to later figures, the omni-directional drone configured for NDT-based structural inspections provides numerous advantages over prior technologies and includes aspects and features that are not found in these earlier technologies. First, the omni-directional drone with an NDT sensor deployment assembly provides a platform that is capable of performing inspection on surfaces of any orientation while also being able to maintain stable contact (or proximity as dictated by the particular NDT sensor utilized) to facilitate collection of reliable measurements. Second, the new inspection system supports a multitude ofNDT inspection sensors including, but not limited to: classical ultrasonic thickness (UT) sensors; Electro-Magnetic Acoustic Transducer (EMAT) sensors; pulsed eddy current (PEC) sensors; and dry-film thickness (DFT) sensors.

As a third advantage or feature, the inspection system provides a platform that has the ability to use and process the output or collected data from optical flow cameras and distance sensors (e.g., point LiDAR components) to control the drone so as to stabilize the drone close to the structure (e.g., in a pre-inspection position and in the inspection position). Fourth, the system's operations provide an automatic way to collect measurements on a single button press (in a GUI, for example) that causes the drone to go in to the sampling location with the support arm, to take measurements via operations of the sensor, and to retreat from the surface of the structure (which may include retracting the extended sensor support back into or onto the support arm). Fifth, the system provides a pilot interface (e.g., a radio controller along with a tablet or other computing device that may be handheld in some cases) to pilot the drone and monitor the flight status via telemetry (e.g., onboard sensor assembly components operating to gather data relevant to flight status). Sixth, the system provides an inspector interface (e.g., a tablet or other computing device that may, as with the pilot's client device, be handheld) to view measurement data and trigger payload (e.g., initiate operations of the NDT sensor and/or associated portions of the NDT sensor deployment assembly).

As a seventh advantage or feature, the inspection system provides a mechanism to engage and retract an attachment mechanism, which may take the form of a magnet, on the inspection sensor (such as when this sensor is an EMAT sensor or the like not requiring a particular contact with the surface). Eighth, the inspection system may include a mechanism as part of the NDT sensor deployment assembly to dispense gel onto the inspection surface prior to placing the NDT sensor in contact with a wall surface (e.g., when the NDT sensor takes the form of a UT sensor). Ninth, the system may include a mechanism that enables the sensor to slide a predefined distance upon the surface being inspected (e.g., in the case of a PEC sensor). Tenth, drone body or frame will include a battery or the drone will have a power tether from the ground to power the components on or carried by the drone including the NDT sensor deployment assembly. As an eleventh advantage or feature, the inspection system is configured to provide uploading of inspection data to the cloud and generating inspection reports in an automatic manner.

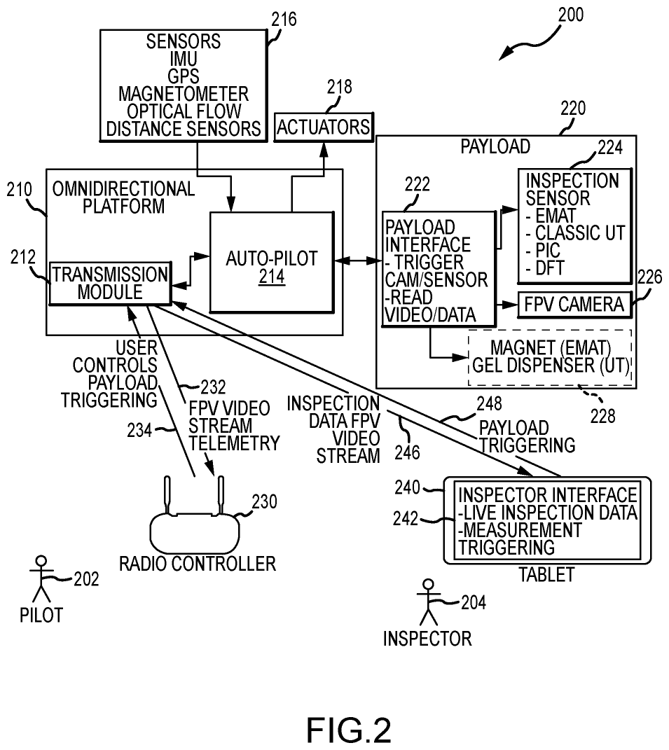

FIG. 2 is a schematic diagram of one useful implementation of an inspection system 200 (e.g., an exemplary embodiment of system 100 of FIG. 1) showing particular features in further detail. As shown, the inspection system 200 includes an omnidirectional platform (e.g., a 360-degree UAV or MAV) 210, which may be configured to carry an NDT sensor payload 220 during its flights. The platform 210 includes a communications transmission module 212 as well as hardware and software for implementing an autopilot mechanism 214 that generates control signals to operate the actuators 218 (rotors, tilting motors, and the like as noted above). Further, the platform 210 is configured to carry a set of sensors 216 that provide their output to the autopilot mechanism 216 and may take the form of an IMU, a GPS device, a magnetometer, a laser, an optical flow component, and one or more distance sensors.

The NDT payload 220 is shown to include a payload interface 222 for interacting with the autopilot mechanism/controller 214 of the platform 210, and it may operate to trigger camera and/or sensor operations of the payload 220 and/or to read or process video and/or data from the payload sensors. The NDT payload 220 includes, in communication with the interface 222, an inspection sensor 224, an FPV camera, and, when useful for attaching/placing a sensor 224 or supporting operations of a sensor 224, an attachment mechanism (e.g., a magnet) and/or a gel or transmission medium dispenser (e.g., for use with an EMAT sensor 224 and a UT sensor, respectively).

The system 200 further includes a radio controller 230 operable by a drone pilot 202 to receive, as shown with arrow 232, a video stream from the FPV camera 226 and telemetry information from the sensors 216. The operator/pilot 202 may operate (e.g., using control sticks, knobs, switches, and/or the like and/or interacting with a GUI of) the radio controller 230 to generate user control signals and payload triggering signals that are transmitted to the auto-pilot/controller 214 of the platform 210 as shown with arrow 234. Additionally, the system 200 includes a client device (shown as a tablet) 240 that operates to generate and display a GUI 242 on its monitor/display device. The GUI 242 provides an inspector interface to an operator (e.g., a structural inspector) 204. When the tablet/device 240 receives inspection data and FPV video stream from the sensor 224 and FPV camera 226, respectively, via the platform 210 as shown with arrow 246, the interface 242 displays live inspection data and provides a button or other visual prompt to allow the operator/inspector 204 to trigger measurements being taken by the sensor 224. The triggering control signals are transmitted from the tablet 24o to the payload 220 via the platform's autopilot/controller 214 as shown with arrow 248.

The autopilot/controller 214 is configured with one or more processors that run code or software to provide the main processing unit of the platform/drone 210. The autopilot 214 processes all the sensor data from the sensors 216 to estimate the state (e.g., position, orientation, and so on) of the platform 210 and controls the actuators 218 to achieve and maintain stabilized flight. The autopilot 214 takes user controls 234 from the radio controller 230 and commands the drone's actuators 218 accordingly (or based on these control signals 234). It has the data interfaces to the payload inspection sensors 224, which allows it to read data and to control the payload (e.g., operations of the sensors 224, the camera 226, and gel dispenser 228 (and any actuators/pumps used to extend a positionable support for the inspection sensors 224 as discussed in system 100 of FIG. 1). The transmission module 212 is responsible for and performs transmitting and receiving of: (a) downlink 232 and 246, which may include video feed, telemetry, and payload/sensor data (e.g., inspection measurements); and (b) uplink 234 and 248, which may include user controls and payload triggering.

As shown, the inspection sensor 224 may take the form of nearly any NDT sensor that is able to: (i) measure surface or wall thickness (e.g., a UT sensor, an EMAT sensor, or the like); (ii) measure corrosion and flaws under a surface (e.g., a PEC sensor); (iii) measure coating thickness on the surface (e.g., a DFT sensor); and/or (iv) perform other NDT inspections. The FPV camera 226 serves as the eyes for the pilot 202 and inspector 204. It provides with a video stream 232, 246 an overview of the surroundings of the drone 210. In operations of the system 200, a real-time view of the FPV camera feed on the radio controller 230 helps the pilot 202 to navigate the drone 210 via signals 234 to desired inspection locations (e.g., surfaces of walls or components of a structure). The payload interface 222 is the interface between the autopilot/controller 214 and the payload sensors 224. It is responsible for triggering the sensor 224 to operate (which can vary in practice among differing sensors 224) and for reading the measurement data from the inspection sensor 224 for proper transmittal as shown at 248 to the inspector client device/tablet 240. The radio controller 230 includes hardware and software components or controls for piloting the drone 210 via control signals 234, triggering the payloads 224 (or these may be triggered by device 240 and inspector 204), and displaying on a screen of the controller 230 the telemetry and the FPV feed received from platform 210 as shown with arrow 232.

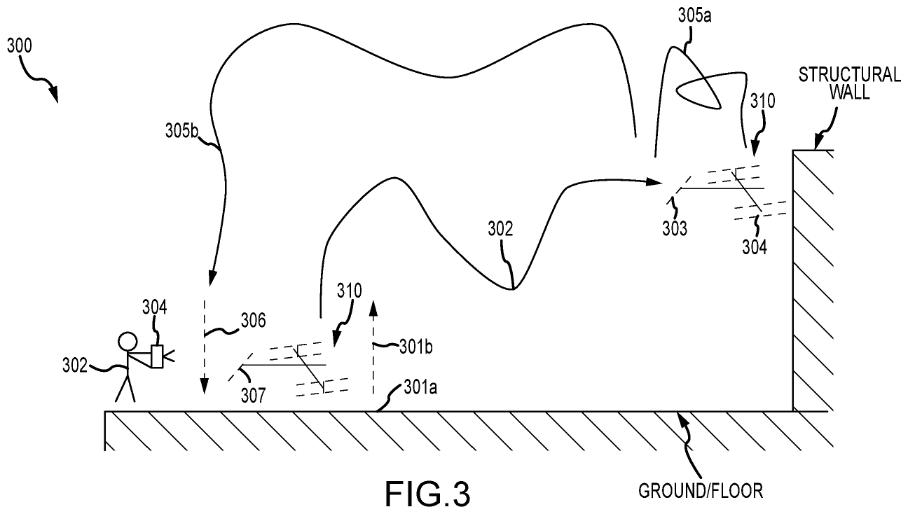

With the inspection system and its components understood, it may be useful at this point in the description to describe its operations or methods used to perform a NDT inspection mission. To this end, FIG. 3 illustrates schematically mission workflow or an inspection process 300 with its various flight phases shown and labeled with reference numbers 301a-307. As shown, a pilot 302 is operating a client device/radio controller 304 to pilot and trigger sensor-based inspections with an omni-directional drone or platform 310. During a pre-flight preparation phase or step 300a, the pilot 302 unboxes the drone 310 from a transport box (not shown) and assembles the support arm and the payload it supports. The pilot 302 then powers up the drone 310, and the drone 310 with its controller will indicate (e.g., on the radio controller 304 and/or via indicator lights and/or audio tunes on the drone 310) when it is ready to fly.

Phase or step 301b is take-off, and the user 302 has the drone powered on/up (e.g., via a button on the drone 310 indicated by an LED or the like) and the radio controller 304 (which may be powered or provided as a tablet or other electronic device) in their hands. On the tablet/controller 304, the pilot 302 sees (or is shown) a ground station interface, which may include a clear and visible button that they can select for “take off” By pressing or selecting it, the drone 310 will arm and safely take-off to a predefined height, which may be a user-selectable parameter or fixed at a default height above the ground/floor. Before arming and taking off, essential checks are done by the drone's autopilot/controller to ensure safe take-off and flight. In some cases, these checks may include operability checks on components of the payload including the NDT sensor, the camera, and so on.

In a free-flight phase or step 302, the drone 310 is controlled to hover at a specified altitude and waits for further instructions or user inputs from the pilot 302 via radio controller 304. Free-flight mode 302 may be aided by additional sensing onboard the drone to reduce the drift (e.g., optical flow components, GPS sensors, and so on may operate to provide data to measure and control drift). Flight behavior in phase 302 typically will be intuitive for visual flight (e.g., pilot 302 observing the drone 310 in the air/space above the ground/floor) and for FPV-based flight (with a same mode used for each). The operator 302 preferably is able to know the presence of obstacles around the drone 310 when in FPV-based flight.

During flight phase or mission step 303, operations of the system are transitioned for sensor measurements. When the pilot 302 approaches a structure or its wall (as shown) for inspections, the drone 310 is controlled to lock onto a surface of the structural wall, which may include maintaining a predefined distance to the surface without any (or with minimal) lateral velocities along the surface. Before transitioning to this locked-on mode, the autopilot or onboard controller is operable to perform necessary checks to ensure stable locking, which may include processing outputs of onboard sensors to determine optical flow quality, LiDAR quality, and so on. In this mode 303, the drone 310 is controlled so as to only approach the surface of the structure and to move away or out from the surface of the structure along the surface's normal (as determined by the autopilot or software on the controller 304 in some cases). The pilot 302, in some embodiments, is averted and prevented by the autopilot from approaching beyond a certain minimal distance to the surface. By checking the FPV stream and having an indication point (e.g., laser/image point), the pilot 302 is able to provide control via controller 304 to align the drone's approach direction along the inspection point's normal.

Flight phase or mission step 304 involves interaction and measurement with and of the surface of the structural wall. Step 304 may be fully automated by configuration of the autopilot/onboard controller of the drone 310. For example, the pilot 302 may press a button on a GUI of the radio control 304, which causes an initiation signal to be sent to the drone 310 causing it to operate to approach the predefined measurement point on the surface by following a flight path coinciding with the normal of the surface. The interaction and measurement performed by the NDT sensor deployment assembly takes place once the sensor is properly positioned relative to the surface, and this may be automated or be triggered by an inspector operating a client device (as discussed with reference to FIGS. 1 and 2). After the measurement is completed, the drone is controlled by its autopilot to retreat back toward the pre-inspection or starting point for measurements.

Step 305a involves moving the drone 310 to a next inspection point on the surface of the structural wall and collecting additional measurements. Step or phase 305b involves the drone 310 being operated by the pilot 302 via the radio control 304 to fly back to the level ground. In step or phase 306, after flying back to a landing position, the pilot 302 typically will simply press a landing button in the GUI of the radio controller to initiate landing as controlled by the onboard autopilot, with some checks being performed to increase the safety of the landing. In step or phase 307, data is downloaded and post-processing is performed. The radio control 304, for example, may guide the operator 302 through the task of downloading all the relevant data collected during the mission 300 such as camera feed, NDT inspection sensor data, a flight log, and so on. In some cases, the measurement data from the NDT sensors may be uploaded directly to the cloud or other digital communications network for access by a reporting system. Further, the flight logs may be uploaded to the cloud for fleet analysis. In some preferred cases, reporting data is generated automatically.

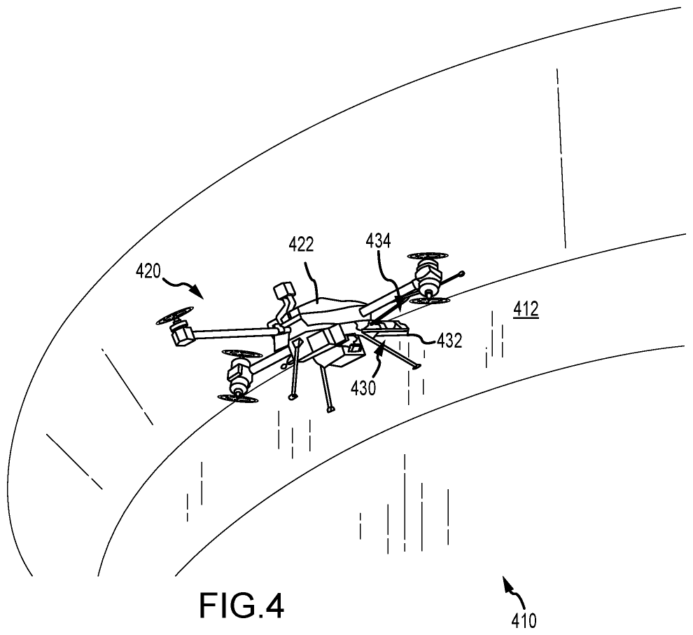

FIG. 4 is side perspective view of an omni-directional drone 420 operating (e.g., hovering at a vertical height) to retain an NDT sensor (i.e., an EMAT sensor) 434 in place for measurements of a surface 412 of a structure wall 410. In this exemplary implementation of an inspection system, the structural wall 410 is the outer wall of a large cylindrical tank such that the surface 412 is curved. The drone or UAV 420 is an omni-directional drone such as the 360° Drone available from Voliro Airborne Robotics or the like, and it is presently operating to hover in a fixed vertical position relative to the surface 412.

The drone 420 includes a body or central frame 422 from which an elongate and rigid support arm 430 extends outward (such as in the plane of the arms supporting the drone's rotors as shown). At the outer end of the support arm 430, an EMAT sensor 434 is provided along with a permanent magnet 432, and, in the measurement phase or mode shown, the magnet 432 is attached to the surface 412 so as to place the EMAT sensor 434 in contact or with a predefined and acceptable airgap between the sensor 434 and the surface 412 (as contact is not required with EMAT inspection technology).

Prior to the operating phase or state shown in FIG. 4, the drone 420 would have been operated to determine (or this would be determined by a base station or RC operated by a pilot) the normal to the surface 412 from the drone's spaced apart pre-inspection location (see phase 303 of FIG. 3). Then, the pilot of the drone 420 would have selected a “go” button to cause the drone to be autopiloted on a flight path coinciding with the determined normal until the magnet 432 contacted and mated via an attracting magnetic force with the surface 412 of the metallic structure 410. The drone 420, as shown, would then be operated to stabilize and hold this inspection position, while the EMAT sensor 434 is operated (in response to a go signal from an inspector's client device or automatically as part of the autopilot routine in some cases) to take measurements of the structure 410 at the inspection point on the surface 412 (e.g., a wall thickness at this point).

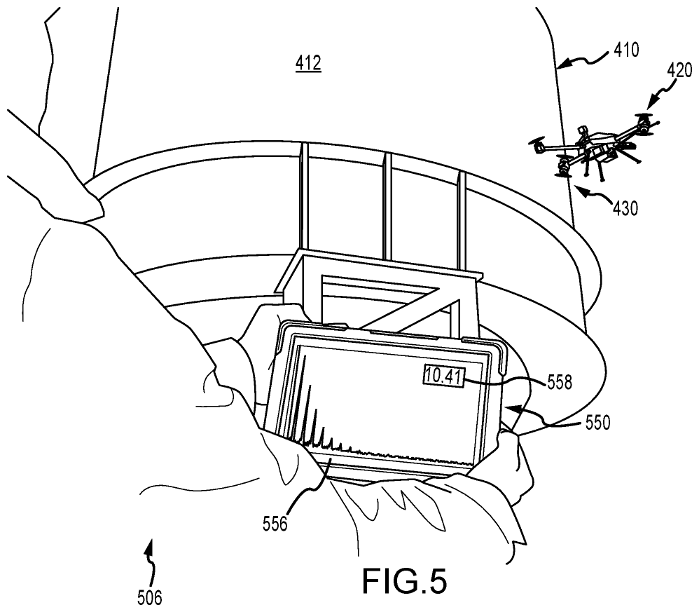

FIG. 5 illustrates the drone 420 of FIG. 4 during an inspection process that involves taking an additional measurement of wall thickness of the structure 410, and the arm 430 is shown to be positioned by the drone 420 with its outer end abutting the surface 412. The EMAT sensor 434 is being operated to take measurements with its data sent to a client device 550 being operated by an inspector/user 506. As shown, the client device 550 has a GUI 556 displayed on its screen/monitor that includes the wall thickness 558 as presently measured by the EMAT sensor 434 being positioned by the drone 420.

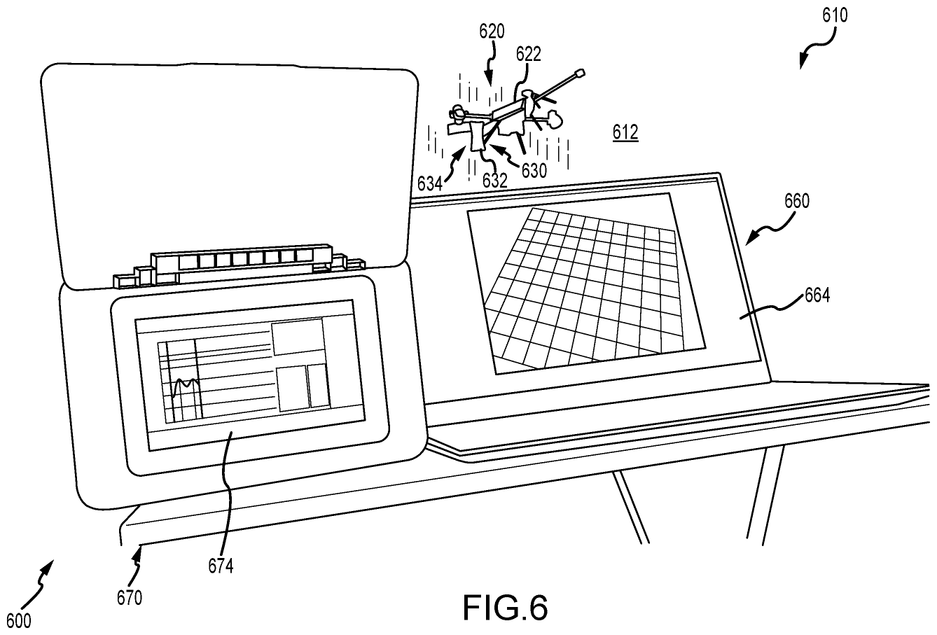

FIG. 6 illustrates an omni-directional drone 620 with a body or central frame 622 from which an elongate and rigid support arm 630 extends some distance (such as 8 to 16 inches or the like). A NDT sensor 632 in the form of a PEC sensor is mounted at the outer or distal end of the support arm 630, and a sled or protective frame 634 is provided outward from the sensor 632. The sled/frame 634 may be generally planar in shape in some cases and be arranged orthogonal to the longitudinal axis of the support arm 630. In some cases, a shock-absorbing member is provided between the sled/frame 634 and the arm 630 that is configured (such as in the form of a piece of resilient material) to absorb forces when the frame/sled 634 contacts the surface 612. As shown, the drone 620 is being operated to hold the support arm 630 normal to the surface 612 of the structure 610 being inspected and with the sled/frame 634 abutting the surface 612. The drone 620 may be moved vertically or horizontally from the illustrated position so as to slide the frame/sled 634 along the surface 612 while retaining the PEC sensor 632 at a desired distance from the surface 612 while it is being operated to take measurements of the surface 612, which can be processed to measure corrosion and flaws under the surface 612.

As shown in FIG. 6, the inspection system 600 includes a first client device 660 that may be operated by a pilot to fly the drone 620, and a GUI 664 is provided on the screen of the device 660 that may present data from onboard sensors and may present a live video feed from an FPV camera on the support arm 630 or elsewhere in the body/frame 622. The system 600 further includes a second client device 670 that may be operated be an inspector, and a GUI 674 is created and displayed on a screen of the device 670 that presents in real-time (or with a minimal delay) results (or collected raw data in some cases) of the measurements performed by the PEC sensor 632 for surface 612.

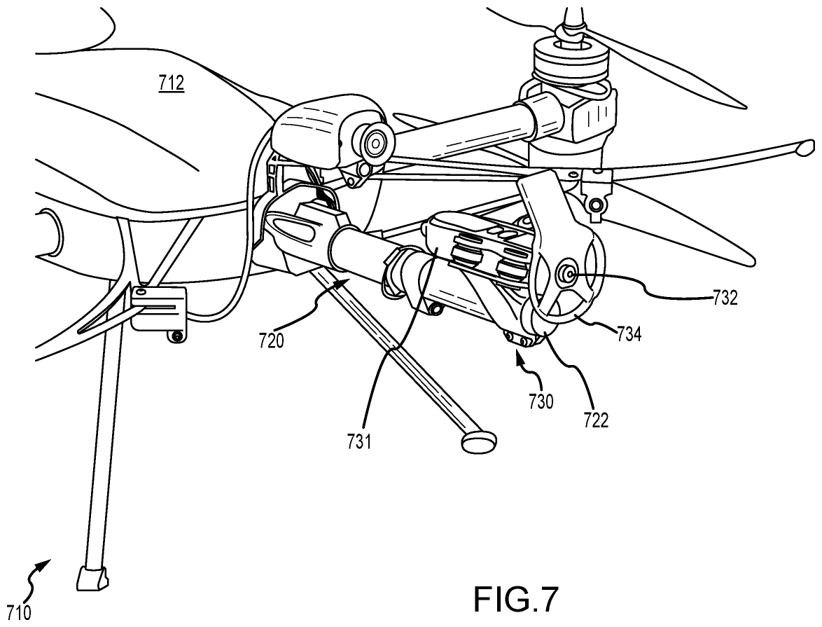

FIG. 7 illustrates another omni-direction drone 710 configured to carry and position an NDT sensor in the form of a DFT sensor. As shown, the omni-directional drone 710 includes a body or central frame 712, and an elongate and rigid support arm 720 extends outward a distance to its outer or exterior end 722. Upon the end 722, a sensor assembly 730 is mounted that includes a frame/body 731 for affixing the assembly 730 to the arm 720. A DFT sensor 732 is positioned in the frame/body 731 with an exposed sensor surface. A protective guard member 734 is provided that extends about the periphery of the exposed surface of the DFT sensor 732 and that, typically, extends outward a predefined distance from the arm end 722 further than the sensor 732 to protect it from damage during inspections. During use, the drone 710 is flown to move the support arm 720 along a normal to a surface being inspected until the guard 734 physically abuts the surface, and, then, the DFT sensor 732 is operated via control signals from an onboard controller/autopilot mechanism. Data from the measurements are transmitted to a client device operated by an inspector, and a GUI is presented that displays the inspection results, which in the case of DFT sensor 732 may be a coating thickness on the surface being inspected.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

I claim:

1. A system for inspecting a structure in a nondestructive manner, comprising:
an omni-directional unmanned aerial vehicle (UAV) including a body;
a support arm extending outward from the body from a first end attached to the body to a second end distal to the body;
a nondestructive testing (NDT) sensor mounted on or in the support arm at or near the second end;
an autopilot module stabilizing flight of the omni-directional UAV during at least one of free flight when in proximity to the structure; and
a surface tracking module, active when the omni-directional UAV is in proximity to the structure, determining a normal of a surface of the structure, wherein the autopilot performs the stabilizing of flight to orient the body with the support arm aligned with the normal to the surface and with the second end of the support arm proximate to the surface.

2. The system of claim 1, wherein the omni-directional UAV operates in response to control signals generated by the autopilot module or received from a radio controller based on user input to follow a flight path whereby a longitudinal axis of the support arm coincides with the normal to the surface and whereby the NDT sensor is positioned in a predefined measurement position relative to the surface of the structure and further wherein the NDT sensor is operated in the predefined measurement position to measure one or more parameters related to the surface of the structure.

3. The system of claim 2, wherein the flight path is contained in a plane that is at an offset angle from a horizontal plane.

4. The system of claim 3, wherein the surface is at least one of a nonplanar surface, a top surface, a bottom surface, and is a non-vertical planar sidewall of the structure.

5. The system of claim 2, further comprising a client device operating to provide a graphical user interface (GUI) on a display screen that includes data associated with the one or more parameters to a user of the client device.

6. The system of claim 5, further comprising a camera capturing a video image of the surface and wherein the GUI is adapted to display the video image of the surface.

7. The system of claim 2, wherein the NDT sensor comprises an electromagnetic acoustic transducer (EMAT) sensor and wherein the one or more parameters includes a wall thickness of the structure.

8. The system of claim 7, further comprising an attachment mechanism comprising a magnet mounted on the second end of the support arm with a mating surface extending outward a distance from the support arm from the EMAT sensor, whereby the magnet is attached to the surface when the sensor is positioned in the predefined measurement position.

9. The system of claim 7, further comprising a positioning assembly mounted on the support arm including a positionable support upon which the magnet and the EMAT sensor are affixed and an actuator operating prior to the measuring of the one or more parameters to extend the positionable support outward from the second end of the support arm to cause the magnet to be attached to the surface and place the EMAT sensor in the predefined measurement position.

10. The system of claim 2, wherein the NDT sensor comprises a piezoelectric ultrasonic transducer (UT) sensor, wherein the one or more parameters includes a wall thickness of the structure, and wherein the system further comprises a pump mechanism mounted on the support arm proximate to the second end operating prior to the measuring of the one or more parameters by the UT sensor to dispense a gel onto the surface.

11. The system of claim 2, wherein the NDT sensor comprises a pulsed eddy current (PEC) sensor, wherein the one or more parameters includes corrosion or flaws under the surface of the structure, and wherein the system further comprises a sled mounted on the second end of the support arm outward from the PEC sensor, whereby the sled slides on the surface while periodic measurements are performed during the measurement of the one or more parameters by the PEC sensor.

12. The system of claim 2, wherein the NDT sensor comprises a dry-film thickness (DFT) sensor and wherein the one or more parameters includes a coating thickness on the surface of the structure.

13. The system of claim 1, further comprising two or more optical flow cameras and distance sensors on the body and wherein the autopilot module processes output of at least two of the optical flow cameras and the distance sensors to generate control signals to perform the stabilizing of the flight of the omni-directional UAV.

14. The system of claim 1, further comprising three or more distance sensors on the body and wherein the autopilot module processes output of the distance sensors to determine the normal to the surface of the structure.

15. A system for inspecting a structure in a nondestructive manner, comprising:
an omni-directional unmanned aerial vehicle (UAV) including a body;
an elongate support arm extending outward from the body to an outer end;
a nondestructive testing (NDT) sensor mounted on or in the support arm at or near the second end; and
a controller determining a normal of a surface of the structure,
wherein the omni-directional UAV operates in response to control signals generated by the controller or received from a radio controller based on user input to follow a flight path whereby a longitudinal axis of the support arm coincides with the normal to the surface and whereby the NDT sensor is positioned in a predefined measurement position relative to the surface of the structure,
wherein the NDT sensor is operated in the predefined measurement position to take measurements related to the surface of the structure, and
wherein the flight path is contained in a plane that is at an offset angle from a horizontal plane, whereby the body is in a non-horizontal orientation while the NDT sensor is operated to take the measurements.

16. The system of claim 15, further comprising a client device operating to provide a graphical user interface (GUI) on a display screen that includes a display of a video image of the surface and an initiate autopilot button selectable by a user of the client device to generate the control signals to cause the omni-directional UAV to follow the flight path.

17. The system of claim 15, wherein the NDT sensor comprises an electromagnetic acoustic transducer (EMAT) sensor, wherein the one or more parameters includes a wall thickness of the structure, and wherein the system further includes an attachment mechanism comprising a magnet mounted on the second end of the support arm with a mating surface extending outward a distance from the support arm from the EMAT sensor, whereby the magnet is attached to the surface when the sensor is positioned in the predefined measurement position.

18. The system of claim 15, wherein the NDT sensor comprises a piezoelectric ultrasonic transducer (UT) sensor, wherein the one or more parameters includes a wall thickness of the structure, and wherein the system further comprises a pump mechanism mounted on the support arm proximate to the second end operating prior to the measuring of the one or more parameters by the UT sensor to dispense a gel onto the surface.

19. The system of claim 15, wherein the NDT sensor comprises a pulsed eddy current (PEC) sensor, wherein the one or more parameters includes corrosion or flaws under the surface of the structure, and wherein the system further comprises a sled mounted on the second end of the support arm outward from the PEC sensor, whereby the sled slides on the surface while periodic measurements are performed during the measurement of the one or more parameters by the PEC sensor.

20. The system of claim 15, wherein the NDT sensor comprises a dry-film thickness (DFT) sensor and wherein the one or more parameters includes a coating thickness on the surface of the structure.

21. A system for inspecting a structure in a nondestructive manner, comprising:
an unmanned aerial vehicle (UAV) including a body;
a support arm extending outward from the body from a first end attached to the body to a second end distal to the body;
a nondestructive testing (NDT) sensor mounted on or in the support arm at or near the second end; and
an autopilot module automatically stabilizing flight of the UAV with the support arm substantially orthogonal to the surface and the second end of the support arm spaced apart a distance from the surface,
wherein the UAV operates in response to control signals generated by the autopilot module or received from a radio controller based on user input to follow a flight path, whereby the NDT sensor is positioned in a predefined measurement position relative to the surface of the structure.

22. The system of claim 21, wherein UAV is configured for omni-directional flight to position and retain the body in any orientation in space and the wherein the flight path is contained in a plane that is at an offset angle from a horizontal plane.

23. The system of claim 21, further comprising a client device operating to provide a graphical user interface (GUI) on a display screen that includes data associated with the one or more parameters to a user of the client device and further wherein the GUI is configured to present an initiate measurements button selectable by a user of the client device to initiate operations of the NDT sensor or to initiate generation of the control signals to cause the UAV to follow the flight path.

24. The system of claim 23, further comprising a camera capturing a video image of the surface and wherein the GUI is adapted to display the video image of the surface.

25. The system of claim 21, wherein the NDT sensor comprises an electromagnetic acoustic transducer (EMAT) sensor and wherein the one or more parameters includes a wall thickness of the structure.

26. The system of claim 25, further comprising an attachment mechanism comprising a magnet mounted on the second end of the support arm with a mating surface extending outward a distance from the support arm from the EMAT sensor, whereby the magnet is attached to the surface when the sensor is positioned in the predefined measurement position.

27. The system of claim 26, further comprising a positioning assembly mounted on the support arm including a positionable support upon which the magnet and the EMAT sensor are affixed and an actuator operating prior to the measuring of the one or more parameters to extend the positionable support outward from the second end of the support arm to cause the magnet to be attached to the surface and place the EMAT sensor in the predefined measurement position.

28. The system of claim 21, wherein the NDT sensor comprises a piezoelectric ultrasonic transducer (UT) sensor, wherein the one or more parameters includes a wall thickness of the structure, and wherein the system further comprises a mechanism mounted on the support arm proximate to the second end operating prior to the measuring of the one or more parameters by the UT sensor to dispense a gel onto the surface.

29. The system of claim 21, wherein the NDT sensor comprises a pulsed eddy current (PEC) sensor, wherein the one or more parameters includes corrosion or flaws under the surface of the structure, and wherein the system further comprises a sled mounted on the second end of the support arm outward from the PEC sensor, whereby the sled slides on the surface while periodic measurements are performed during the measurement of the one or more parameters by the PEC sensor.

30. The system of claim 21, wherein the NDT sensor comprises a dry-film thickness (DFT) sensor and wherein the one or more parameters includes a coating thickness on the surface of the structure.

31. The system of claim 21, further comprising two or more optical flow cameras and distance sensors on the body and wherein the autopilot module processes output of at least two of the optical flow cameras and the distance sensors to generate control signals to perform the stabilizing of the flight of the omni-directional UAV.

32. The system of claim 21, further comprising three or more distance sensors on the body and wherein the autopilot module processes output of the distance sensors to determine the normal to the surface of the structure.

33. The system of claim 21, wherein the autopilot module determines the normal to the surface of the structure, wherein the stabilizing of flight of the omni-directional UAV is performed such that the support arm is aligned with the normal to the surface, and wherein the UAV operates in response to control signals generated by the autopilot module or received from a radio controller based on user input to follow the flight path which is configured such that a longitudinal axis of the support arm coincides with the normal to the surface of the structure.
